(19) United States
(12) Patent Application Publication
(10) Pub. No.: US 2013/0211846 A1
(43) Pub. Date: Aug. 15, 2013

(54) ALL-PASS FILTER PHASE LINEARIZATION OF ELLIPTIC FILTERS IN SIGNAL DECIMATION AND INTERPOLATION FOR AN AUDIO CODEC

(71) Applicants: Jonathan A. Gibbs, Windermere (GB); James P. Ashley, Naperville, IL (US); Udar Mittal, Hoffman Estates, IL (US)

(72) Inventors: Jonathan A. Gibbs, Windermere (GB); James P. Ashley, Naperville, IL (US); Udar Mittal, Hoffman Estates, IL (US)

(73) Assignee: MOTOROLA MOBILITY, INC., Libertyville, IL (US)

(21) Appl. No.: 13/396,259

(22) Filed: Feb. 14, 2012

(51) Int. Cl. G10L 19/00

(52) U.S. Cl. 704/500; 704/E19.001

(57) ABSTRACT

An audio signal processing system includes parallel speech and generic audio signal processing paths. One path includes a linear predictive coder and a resampling filter having a non-linear phase characteristic. A phase compensation filter is disposed along the one of the processing paths to compensate for the non-linearity of the resampling filter thereby enabling relatively seamless switching between the coders resulting in a reduction of audio artifacts that would otherwise result from the non-linear phase characteristic of the resampling filter during playback.

### CROSS REFERENCE TO RELATED APPLICATIONS

The present disclosure is related to co-pending and commonly assigned U.S. application Ser. No. 13/342,462 filed 3 Jan. 2012 entitled “Method and Apparatus for Processing Audio Frames to Transition Between Different Codecs”, the contents of which are incorporated herein by reference.

### FIELD OF THE DISCLOSURE

The present disclosure relates generally to audio signal processing and, more particularly, to all-pass filter phase linearization of elliptic filters in signal decimation and interpolation for an audio codec.

### BACKGROUND

The Enhanced Voice Services (EVS) codec under consideration for implementation by the Third Generation Partnership Project (3GPP) Long Term Evolution (LTE) wireless communication protocol has ambitious requirements for both speech and music & mixed content signals. One way to solve this problem would be to use two parallel cores optimized for each of the two signal types like speech and non-speech signals, e.g., music (otherwise referred to as generic audio signals). To process both speech and generic audio signals, a classifier or discriminator determines, on a frame-by-frame basis, whether an audio signal is more or less speech-like and directs the signal to either a speech codec or a generic audio codec based on the classification. The EVS and other hybrid coders code more speech-like (speech audio) signals using Linear Predictive Coding (LPC). The coding of less speech-like (generic audio) signals is generally performed using a frequency domain transform codec. For example a codec optimized for use in 3GPP EVS could code more speech-like signals using a critically sampled Code Excited Linear Prediction (CELP)-based codec core sampled at 12 kHz or 16 kHz and to code less speech-like signals using a Modified Discrete Cosine Transform (MDCT)-based codec core.

A good decimator is required for the CELP core but seamless switching between the different core types, e.g., the LPC core and the frequency domain core, is required. Elliptic filters have fast roll-offs with modest orders and low delays making them good candidate decimation filters. In Elliptic filters, as illustrated in FIG. 1, the phase is non-linear so switching between cores is not seamless. Symmetric Finite Impulse Response (FIR) filters have linear phase but long delays and many taps.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates Non Linear Phase of an elliptic filter.

FIGS. 2A and 2B illustrate alternative audio encoder embodiments using an all-pass filter to compensate for lack of phase linearity.

FIGS. 3A and 3B illustrate alternative audio decoder embodiments using an all-pass filter to compensate for lack of phase linearity.

FIGS. 4A and 4B illustrate alternative audio encoder/decoder systems using an all-pass filter to compensate for lack of phase linearity.

FIG. 5A is a graphical illustration of all-pass filter phase response.

FIG. 5B is a graphical illustration of group delay for different filters.

FIG. 6 illustrates the merging of the encoder phase correction filters into the decoder such that the all-pass filter in the decoder results in an overall linear phase for the two lowpass filters in the encoder and decoder.

FIG. 7 illustrates the all-pass phase correction filter in the same path as the lowpass filter of the encoder and in the decoder the all-pass phase correction filter is in the parallel path without the lowpass filter.

FIG. 8 illustrates the all-pass phase correction filter in the same path as the lowpass filter of the decoder and in the encoder the all-pass phase correction filter is in the parallel path.

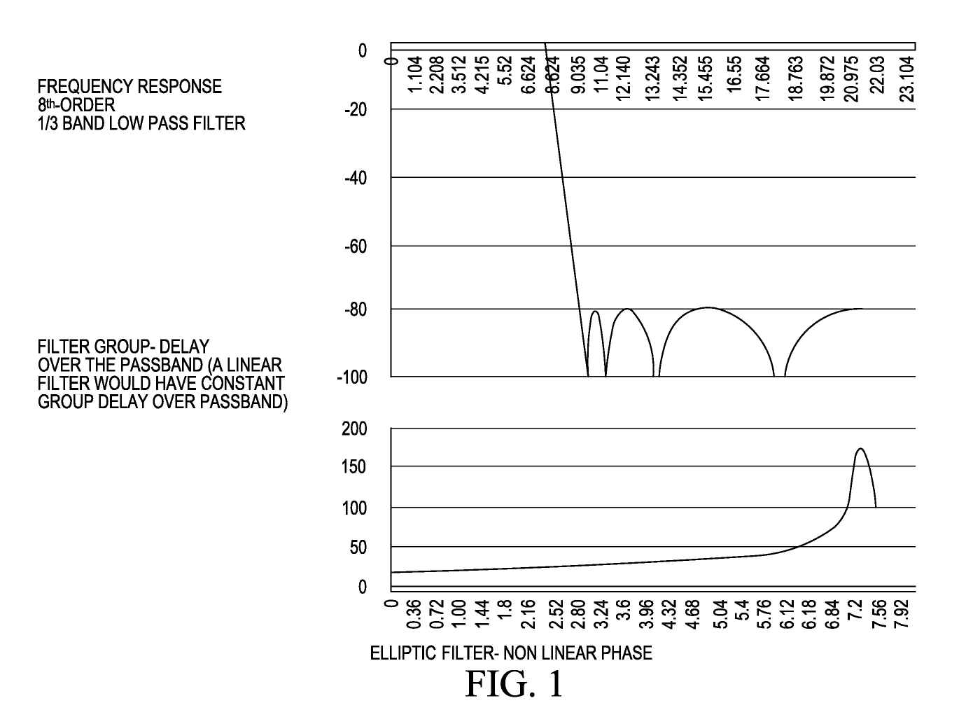

### DETAILED DESCRIPTION

Generally many audio signals have both speech and non-speech like characteristics. For examples an audio signal may include both speech and music. As used herein, a speech signal refers to an audio signal having more speech-like characteristics and a generic audio signal refers to an audio signal having less speech-like characteristics, e.g., music. Whether an audio signal is as a speech signal or a generic signal is dependent on the classification thereof, usually on a frame-by-frame basis, by a classifier or discriminator. Audio signal classifiers are well known generally by those of ordinary skill in the art and hence not described further herein.

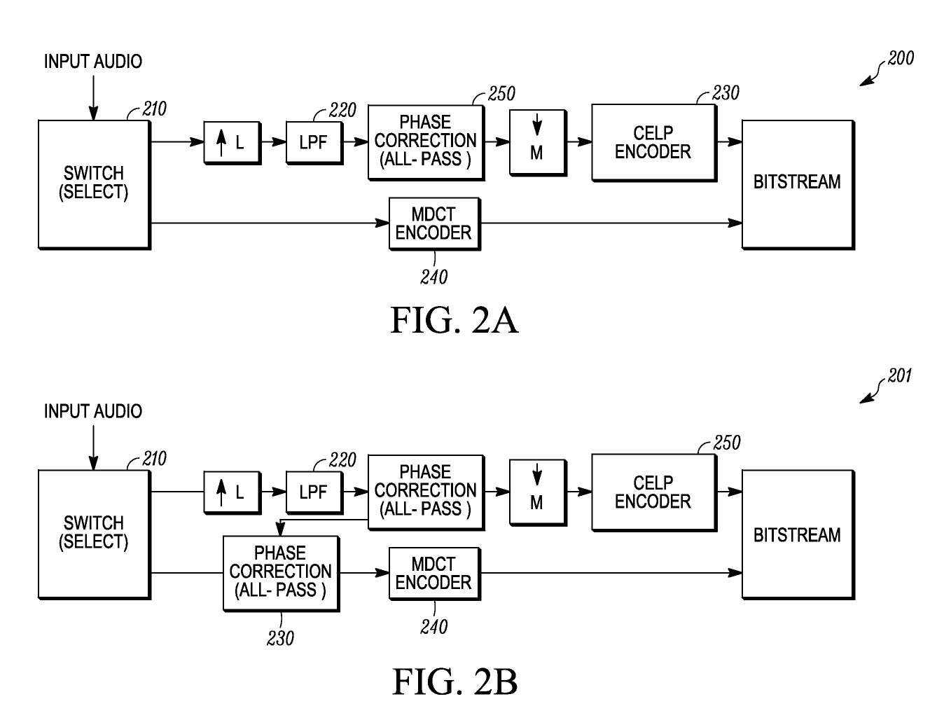

FIGS. 2A and 2B illustrate different embodiments of a hybrid audio encoder 200, 201, respectively, capable of encoding an input audio signal comprising a sequence of frames having different characteristics. For example, the frames may be characterized as speech frames or generic audio signal frames, or the frames may be characterized as different types of speech frames. In any case, the different frames types are most effectively encoded using different encoder cores. Some examples are discussed further below. In FIG. 2 common elements are identified by commoner reference numerals. The encoders each comprises a switch or discriminator 210 configured to discriminate frames of the input audio signal based on a signal characteristic and to select which frames of the input signal are encoded in a first encoder or second encoder. Discriminators for this purpose are well known generally by those having ordinary skill in the art and are not discussed further herein.

In FIGS. 2A and 2B, the encoder comprises generally a first encoder path and a second encoder path coupled to the output of the switch 210. The first encoder path includes a first resampling filter 220 that exhibits a non-linear phase characteristic. The first encoder path includes a first encoder 230 having an input coupled to an output of the first resampling filter 220 wherein the first encoder is configured to produce a first audio signal by encoding a first frame of the input signal after resampling by the first resampling filter. In one embodiment, the first encoder has a linear predictive coding (LPC)-based core and in one particular implementation the first encoder is Code Excited Linear Prediction (CELP)-based core. Other LPC encoders based cores may be used alternatively.

In FIGS. 2A and 2B, the second encoder path includes a second encoder 240 configured to produce a second audio signal by encoding a second frame of the input signal. In one embodiment, the second encoder has a frequency domain transform core and in one particularly implementation the second encoder is a Modified Discrete Cosine Transform-based core. Other frequency domain transform encoders based cores may be used alternatively. In yet another alternative to that illustrated in FIGS. 2A and 2B, the first encoder has a linear predictive coding-based core and the second encoder has a linear predictive coding-based core. Such an embodiment may implement Algebraic CELP (ACELP) cores. The different CELP cores may both use filters, for example IIR filters, for different down-sampling rates. Phase matching all pass filters may also be required in one or both paths for this alternative embodiment. Thus according to this alternative, the second encoder path includes a second resampling filter that may or may not exhibits a non-linear phase characteristic. The input of the second encoder is coupled to an output of the second resampling filter wherein the second encoder is configured to produce the second audio signal by encoding the second frame of the input signal after resampling by the second resampling filter.

Linear predictive cores are well suited for encoding speech signals. In this regard, the first resampling filter may be lowpass filter. In embodiments where both encoder paths include a linear predictive encoder, the second resampling filter may also be a lowpass filter. In one embodiment, the resampling filter is an Elliptic filter. As noted, Elliptic filters have fast roll-offs with modest orders and low delays making them good candidate decimation filters. In Elliptic filters, however, the phase is non-linear so switching between cores is not seamless. In other embodiments, the resampling filter may be any of a family of Infinite Impulse Response (IIR) filters that exhibit a non-linear phase or non-uniform group delay property. In some embodiments, a delay element is disposed in the encoder path without the resampling filter, wherein the delay element compensates for delay associate with the first resampling filter.

The reason for resampling is that the speech coder may operate at a lower sampling rate than the audio coder. There may also be auxiliary coding of higher frequency information in the speech path. The coding of higher frequencies is optional, but will be used in practice to equalize the coded bandwidths of the speech and audio paths. Speech coding at higher sampling rates is subject to much higher complexity demands, as well as lower coding efficiency (i.e., more bits are required to produce equivalent quality) and thus will not be used in some applications.

In one embodiment, an all-pass filter is used to compensate for lack of phase linearity in the filter path or in the alternate coded path of the encoder. Alternatively, two all-pass filters may be combined and placed up-front in either branch or path of the encoder. Thus in FIGS. 2A and 2B, a phase compensation filter 250 disposed along the first encoder path upstream of the first encoder 230 or along the second encoder path upstream of the second encoder 240. In FIG. 2A, the phase compensation filter is disposed in the first encoder path and in FIG. 2B the phase compensation filter is disposed in the second encoder path.

The phase compensation filter is configured to filter the input signal before encoding such that characteristics of the first audio signal and the second audio signal are substantially similar. In other words the similarity of the first and second audio signals is more similar in the present of the compensation filter than would be the case in the absence of the phase compensation filter. The similarity of the first and second audio signals may be measured quantitatively in terms of phase, or correlation, or signal-to-noise ratio (SNR) or some other measurable signal characteristic or a combination of such characteristics. The result is a reduction in audible artifacts, resulting from the non-linear phase characteristic of the resampling filter, of the first audio signal combined with the second audio signal, for example during playback of the audio signal.

In one embodiment, the all-pass filter structure has unity gain (all-pass). Also, the numerator and denominator exhibit a time reversal property. In other words, whatever value of z, the numerator and denominator have same magnitudes, as in the following ratio.

H(z)=0.481177−1.150582 z⁻¹−0.053944 z⁻²+2.226390 z⁻³−1.394225 z⁻⁴−1.042799 z⁻⁵+z⁻⁶/1.0−1.042799 z⁻¹−1.394225 z⁻²+2.226390 z⁻³−0.053944 z⁻⁴−1.150582 z⁻⁵+0.481177 z⁻⁶

For a phase compensation filter cascaded with a lowpass filter as in FIG. 2A, the goal is to complement the group delay and approach linear phase. Complementing the group delay refers to making the sum of lowpass filter group delay and the phase compensating filter group delay as nearly constant as possible. For phase compensation filters in the path without the lowpass filter, the goal is to match the group delays in the two paths, i.e., design the all-pass filter such that its group delay is as close to the group delay of the lowpass filter as possible. A constant delay offset between the two paths, representing a simple delay, is acceptable within the design criteria.

In one embodiment, the resampling filter and the phase compensation filter are in the first encoder path wherein the first resampling filter and the phase compensation filter have a joint phase characteristic that is nearly linear in a pass band.

Generally, the required accuracy of the phase correction is dependent on the accuracy of the speech coder. For example, a lower order phase compensation filter may be sufficient in cases where higher frequency coding of the original signal is not very accurate as is typical of a low bit rate speech codec. Thus in the case where higher frequency mapping of the original signal is not very accurate, the approximation of the phase characteristic of the resampling filters need not be as accurate because the speech coder will distort the signal to some extent. Where higher frequency mapping of the original signal is more accurate, as is typical higher bit rate speech codecs, the phase correction is more critical since these codecs perform higher frequency content coding better.

It may be possible to balance complexity of the encoder and decoder (respectively). For example, on the encoder side, the speech path is usually the worst case complexity path. Thus in some embodiments, worst case complexity can be reduced by placing the phase compensation filter in the generic signal coder path. On the decoder side, however, the generic signal coder path is likely the worst case complexity. Thus in the decoder, the compensation filter is disposed in the speech signal coder path.

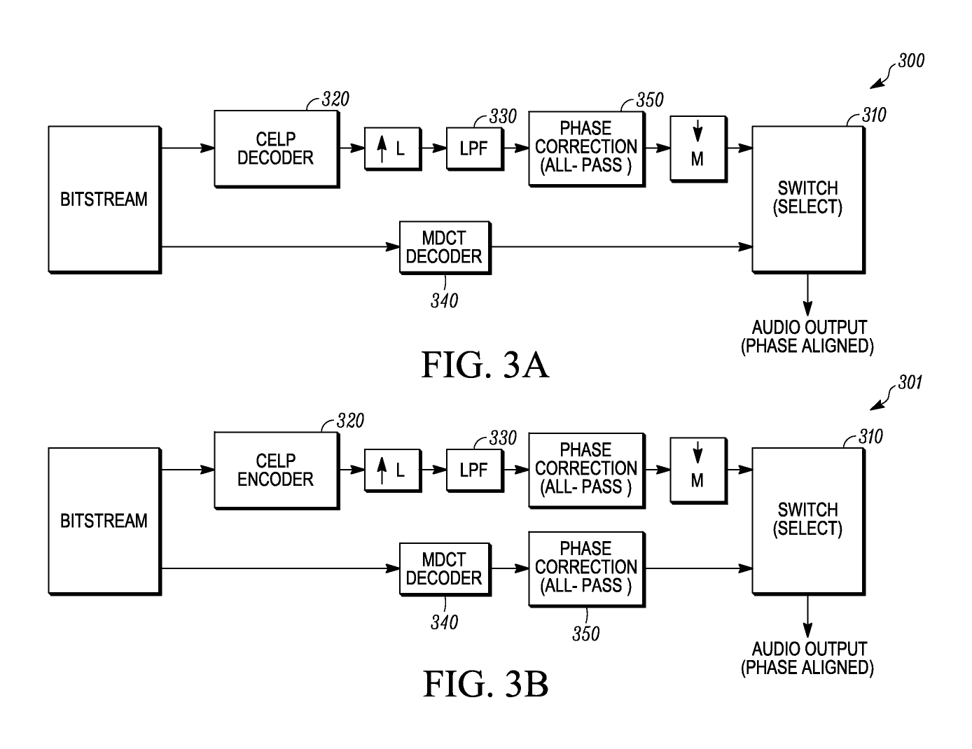

FIGS. 3A and 3B illustrate different embodiments of a hybrid audio decoder 300, 301, respectively, capable of decoding an input audio signal comprising a sequence of frames having different characteristics. The decoder comprises generally a first decoder path and a second decoder path coupled to an output switch 310. The first decoder path includes a first decoder 320 configured to produce a first decoded audio signal by decoding a first encoded bitstream. The first decoder path also includes a first resampler filter 330 that exhibits a non-linear phase characteristic. The first resampler filter is coupled to an output of the first decoder wherein the first resampler is configured to produce a resampled first decoded audio signal by resampling the first decoded audio signal. In one embodiment, the first decoder has a linear predictive coding-based core and in one particular implementation the first encoder is Code Excited Linear Prediction (CELP)-based core. Other LPC encoders based cores may be used alternatively.

In FIGS. 3A and 3B, the second encoder path includes a second decoder 340 configured to produce a second decoded audio signal by decoding a second encoded bitstream. In one embodiment, the second decoder has a frequency domain transform core and in one particularly implementation the second encoder is a Modified Discrete Cosine Transform-based core. Other frequency domain transform encoders based cores may be used alternatively. In yet another alternative to that illustrated in FIGS. 3A and 3B, the first decoder has a linear predictive coding-based core and the second decoder has a linear predictive coding-based core. According to this latter alternative, the second decoder path includes a second resampling filter that may or may not exhibit a non-linear phase characteristic. The second resampler filter is coupled to an output of the second decoder wherein the second resampler is configured to produce a resampled second decoded audio signal by resampling the second decoded audio signal. A further assumption regarding this latter alternative embodiment is that the first decoded audio signal and the second decoded audio signal are sampled at different rates.

As discussed linear predictive cores are well suited for encoding speech signals. In this regard, the first resampling filter may be lowpass filter. In embodiments where both encoder paths include a linear predictive coder, the second resampling filter may also be a lowpass filter. In one embodiment, the resampling filter is an Elliptic filter. As noted, Elliptic filters have fast roll-offs with modest orders and low delays making them good candidate decimation filters. In Elliptic filters, however, the phase is non-linear so switching between cores is not seamless. In other embodiments, the resampling filter may be any of a family of Infinite Impulse Response (IIR) filters that exhibit a non-linear phase or non-uniform group delay property. In some embodiments, a delay element is disposed in the decoder path without the resampling filter, wherein the delay element compensates for delay associate with the first resampling filter.

In one embodiment, an all-pass filter is used to compensate for lack of phase linearity in the filter path or in the alternate coded path of the decoder. Alternatively, two all-pass filters may be combined and placed at the decoder output of either branch or path. Thus in FIGS. 3A and 3B, a phase compensation filter 350 disposed along the first encoder path downstream of the first decoder 320 or along the second decoder path downstream of the second decoder 340. In FIG. 3A, the phase compensation filter is disposed in the first decoder path and in FIG. 3B the phase compensation filter is disposed in the second decoder path.

The phase correction filters on the encoder/decoder may or may not be grouped together. That is, there may be an advantage to implementing He(z) and Hd(z) as a series combination He(z)*Hd(z). For example if He(z) is an all-pass-filter that linearizes the phase of the resampling filter at the encoder side and the Hd(z) is a corresponding all-pass-filter that linearizes the phase of the resampling filter at the decoder side, then instead of using He(z) and Hd(z) at the encoder and decoder respectively, alternate all-pass filters He′(z) and Hd′(z) can be used at the encoder and decoder sides such that the phase characteristics of He′(z)*Hd′(z) is equal to the phase characteristic of He(z)*Hd(z). This may be true of the filter in the speech path, or in the alternative audio path embodiment.

The phase compensation filter is configured to filter the first audio signal after decoding such that characteristics of the first audio signal and the second audio signal are substantially similar. In other words the similarity of the first and second audio signals is more similar in the presence of the phase compensation filter than would be the case in the absence of the phase compensation filter. As noted, the similarity of the first and second audio signals may be measured quantitatively in terms of phase, correlation, signal-to-noise ratio (SNR) or some other measurable signal characteristic.

In FIGS. 3A and 3B, the decoder further comprises a switch 360 coupled to an output of the first decoder path and to an output of the second decoder path. The switch configured to combine the first bitstream output from the first decoder path with second bitstream output from the second decoder path, thereby reconstructing the original encoded input audio signal. The decoder outputs are switched between the first and second decoder paths, e.g., between the generic audio coder and speech coder. During switching, the phase differences between the bitstreams of the first and second decoder paths can cause a “clicks” and/or “pops” depending on which frequencies are out-of-phase. The phase compensation filter reduces these audible artifacts. The all-pass phase compensation filter enables relatively seamless switching between the outputs of the different decoders, thus eliminating or at least reducing audible artifacts that occur during playback.

In one embodiment, the resampling filter and the phase compensation filter are in the first decoder path wherein the first resampling filter and the phase compensation filter have a joint phase characteristic that is nearly linear in a pass band.

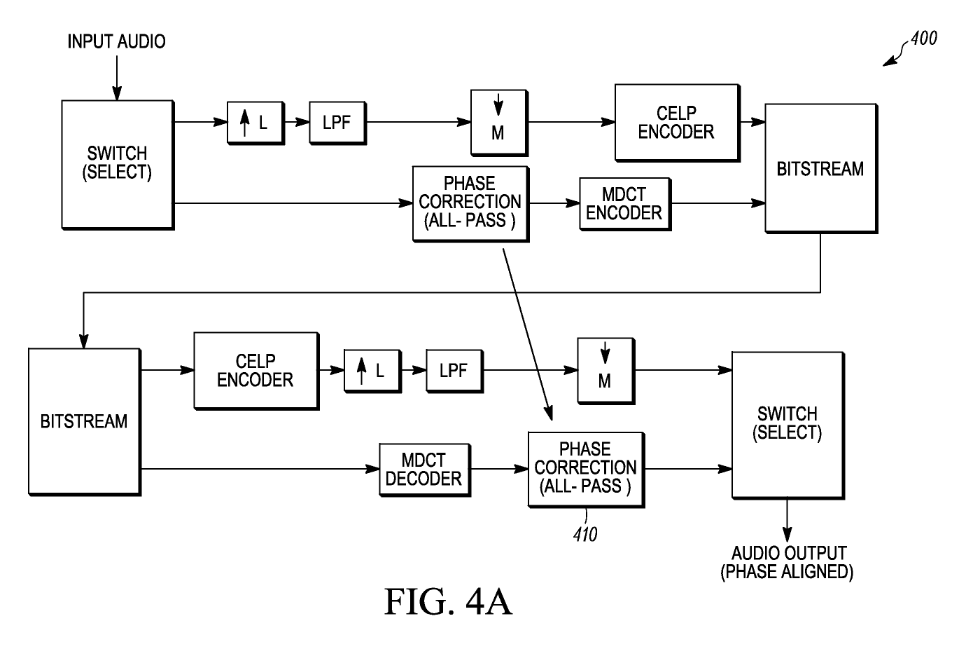

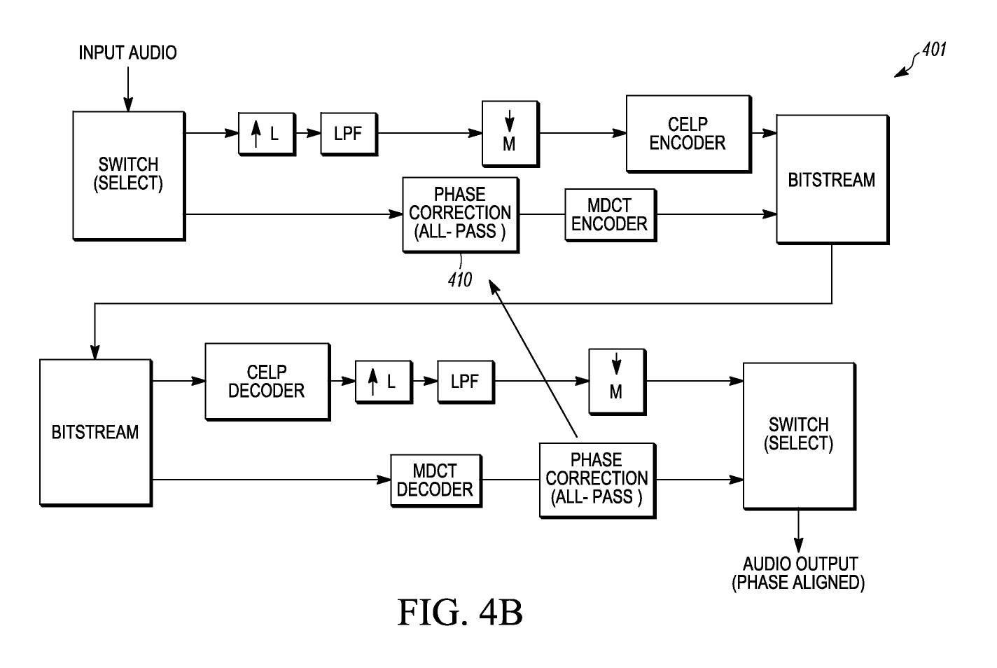

An all-pass filter may also be used to compensate for lack of phase linearity in a system including an encoder and a decoder. This embodiment combines the phase correction filters from each of the encoder and decoder paths into a single phase correction filter at the decoder. The phase compensation filter may be disposed in either the encoder path or the decoder path. The system 400 of FIG. 4A illustrates a single phase correction filter 410 placed in the decoder path. The system 401 of FIG. 4B illustrates a single phase correction filter 410 placed in the encoder path. Generally the encoder and decoder resampling filters need not have exactly the same transfer functions. Also, the phase correction filters do not need to be exact. This is subject to tuning for a particular configuration.

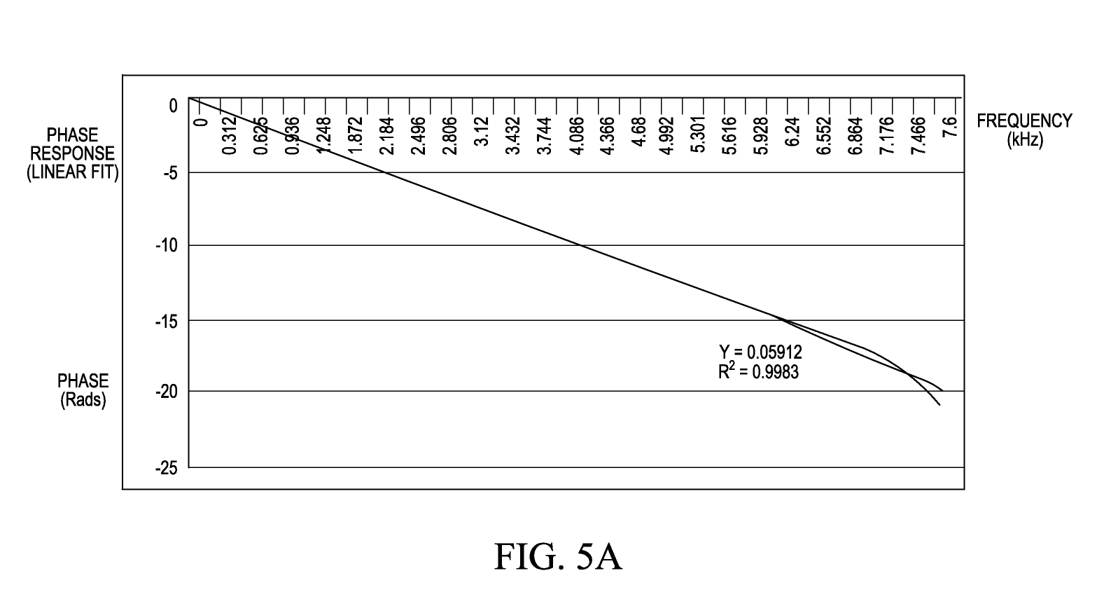

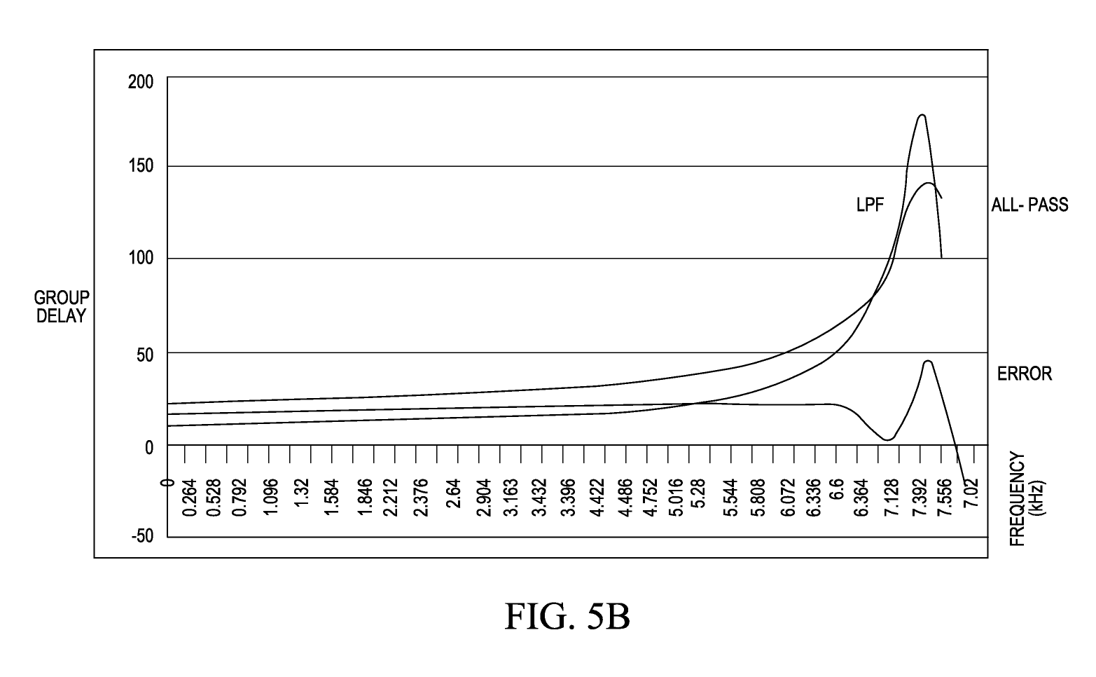

FIG. 5A illustrates the effect of placing the phase correction filter in the same path as the resampling filter (e.g., the lowpass filter) and the improved phase linearity. FIG. 5B illustrates the effect of placing the phase correction filter in the path parallel to the path having the resampling filter and the matching the group delay of the phase correction filter to that of the decimation or resampling filter. It can be observed that there is a fixed offset between the group delay of the filter and that of the matching phase correction filter. This difference represents a simple delay between the two branches.

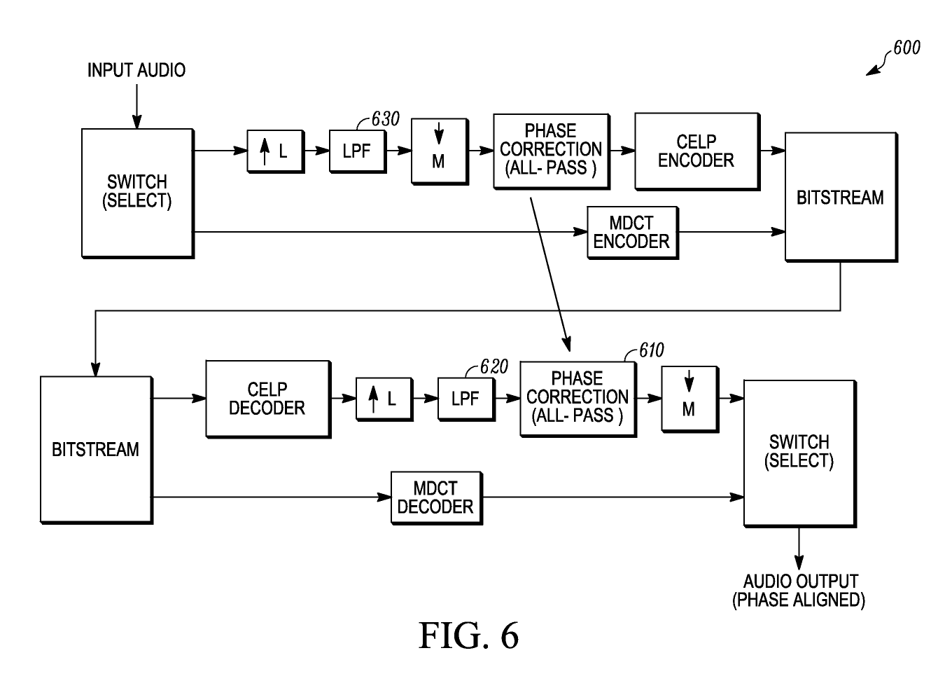

In the system 600 of FIG. 6, the encoder phase correction filter of the encoder is moved into the decoder path having the lowpass filter 620 such that the all-pass filter 610 in the decoder results in an overall linear phase for the two lowpass filters 620, 630 in the encoder and decoder.

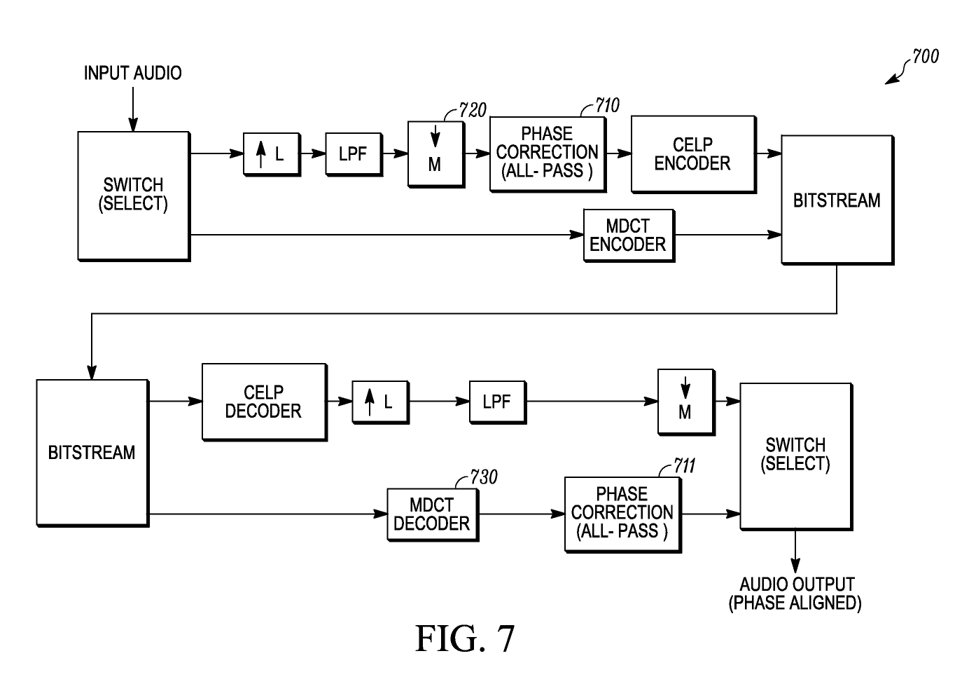

In the system 700 of FIG. 7, the all-pass phase correction or compensation filter 710 of the encoder is placed in the same path as the lowpass filter 720. In the decoder, the all-pass phase correction filter 711 is disposed in the path parallel to the path having the resampling filter, i.e., the path having the MDCT decoder 730.

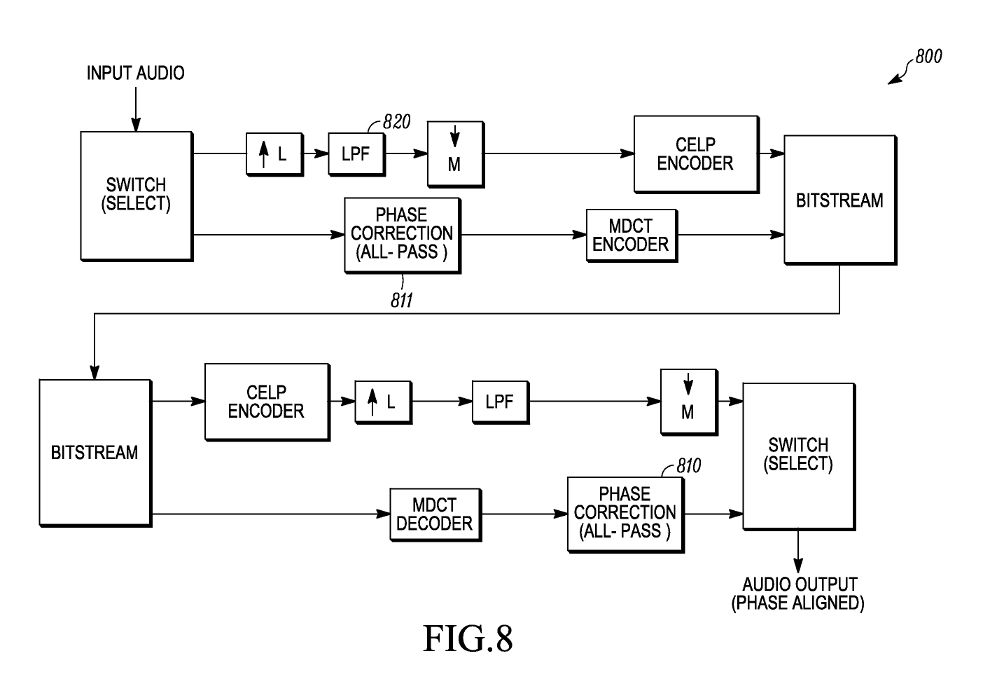

In the system 800 of FIG. 8, the all-pass phase compensation filter 810 of the decoder is placed in the path opposite the lowpass filter 820 and in the encoder the all-pass phase correction filter 811 is in the parallel path, i.e., the decoder path having the MDCT decoder.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. An audio encoder for encoding an input signal, comprising:
a first encoder path including a first resampling filter that exhibits a non-linear phase characteristic,
the first encoder path including a first encoder having an input coupled to an output of the first resampling filter, the first encoder configured to produce a first audio signal by encoding a first frame of the input signal after resampling by the first resampling filter;
a second encoder path including a second encoder configured to produce a second audio signal by encoding a second frame of the input signal; and
a phase compensation filter disposed along the first encoder path upstream of the first encoder or along the second encoder path upstream of the second encoder,
the phase compensation filter configured to filter the input signal before encoding such that characteristics of the first audio signal and the second audio signal are more similar than in the absence of the phase compensation filter.

2. The encoder of claim 1, wherein the first resampler filter is an elliptic filter.

3. The encoder of claim 1 further comprising a delay element in the second decoder path, wherein the delay element compensates for delay associated with the first resampling filter.

4. The encoder of claim 1, the first encoder has a linear predictive coding-based core and the second encoder has a frequency domain transform core.

5. The encoder of claim 4, the first encoder is Code Excited Linear Prediction (CELP)-based core and the second encoder is a Modified Discrete Cosine Transform-based core.

6. The encoder of claim 1, the first encoder has a linear predictive coding-based core and the second encoder has a linear predictive coding-based core.

7. The encoder of claim 6,
the second encoder path including a second resampling filter that exhibits a non-linear phase characteristic,
the input of the second encoder coupled to an output of the second resampling filter, the second encoder configured to produce the second audio signal by encoding the second frame of the input signal after resampling by the second resampling filter,
wherein the first audio signal and the second audio signal are sampled at different rates.

8. The encoder of claim 1 further comprising a discriminator configured to discriminate frames of the input audio signal based on a signal characteristic, the discriminator configured to select which frames of the input signal are encoded by the first encoder and by the second encoder.

9. The encoder of claim 1, wherein audible artifacts, resulting from the non-linear phase characteristic of the resampling filter, of the first audio signal combined with the second audio signal are reduced.

10. The encoder of claim 1, wherein the phase compensation filter is in the first encoder path and wherein the first resampling filter and the phase compensation filter have joint phase characteristic that is nearly linear in a pass band.

11. An audio decoder comprising:
a first decoder path including a first decoder configured to produce a first decoded audio signal by decoding a first encoded bitstream;
the first decoder path including a first resampler filter that exhibits a non-linear phase characteristic, the first resampler filter coupled to an output of the first decoder, the first resampler configured to produce a resampled first decoded audio signal by resampling the first decoded audio signal;
a second decoder path including a second decoder configured to produce a second decoded audio signal by decoding a second encoded bitstream; and
a phase compensation filter disposed along the first decoder path downstream of the first decoder or along the second decoder path downstream of the second decoder,
the phase compensation filter configured to filter the resampled first decoded audio signal or to filter the second decoded audio signal such that the resampled first decoded audio signal and second decoded audio signal have more similar characteristics than in the absence of the phase compensation filter.

12. The decoder of claim 11, wherein the first resampler filter is an elliptic filter.

13. The decoder of claim 11 further comprising a delay element in the second decoder path, wherein the delay element compensates for delay associate with the first resampling filter.

14. The decoder of claim 11 further comprising a switch coupled to an output of the first decoder path and to an output of the second decoder path, the switch configured to combine a first bitstream output from the first decoder path with a second bitstream output from the second decoder path.

15. The decoder of claim 11, wherein the first encoder has a linear predictive coding-based core and the second encoder has a frequency domain transform core.

16. The decoder of claim 15, wherein the first encoder is Code Excited Linear Prediction (CELP)-based core and the second encoder is a Modified Discrete Cosine Transform-based core.

17. The decoder of claim 11, wherein the first encoder has a linear predictive coding-based core and the second encoder has a linear predictive coding-based core.

18. The decoder of claim 17,
the second decoder path including a second resampling filter that exhibits a non-linear phase characteristic, the second resampler filter coupled to an output of the second decoder, the second resampler configured to produce a resampled second decoded audio signal by resampling the second decoded audio signal,
wherein the first decoded audio signal and the second decoded audio signal are sampled at different rates,
the phase compensation filter configured to filter the resampled first decoded audio signal or to filter the resampled second decoded audio signal.

19. The decoder of claim 11, wherein audible artifacts, resulting from the non-linear phase characteristic of the resampling filter, of the resampled first decoded audio signal combined with the second decoded audio signal are reduced.

20. The decoder of claim 10, wherein audible artifacts, resulting from the non-linear phase characteristic of the resampling filter, are reduced during playback of the resampled first decoded audio signal combined with the second decoded audio signal.

21. An audio signal processor comprising:
a first processing path including a resampling filter that exhibits a non-linear phase characteristic,
the first processing path including a first coder coupled to the resampling filter, the first coder configured to produce a first output signal by coding a first frame of an audio bit stream;
a second processing path including a second coder configured to produce a second output signal by coding a second frame of the audio bit stream;
an all-pass phase compensation filter coupled to the resampling filter in the first processing path; and
a switch coupled to an output of the first and second processing paths, wherein the switch seamlessly switches between the first out signal and the second output signal.
